(19) United States
(12) Patent Application Publication
(10) Pub. No.: US 2019/0009186 A1
(43) Pub. Date: Jan. 10, 2019

(54) BUBBLE CAPS FOR DISTILLATION PLATES IN A FRACTIONATING COLUMN

(71) Applicant: Corson Distilling Systems, Inc., Boise, ID (US)

(72) Inventors: Joshua M. Corson, Boise, ID (US); Tory J. Corson, Boise, ID (US)

(21) Appl. No.: 15/645,857

(22) Filed: Jul. 10, 2017

(51) Int. Cl. B01D 3/20

(52) U.S. Cl. CPC B01D 3/205

(57) ABSTRACT

A bubble cap for a distillation plate is provided. The bubble cap includes a substantially annular plate including an inner surface defining a first opening and substantially parallel upper and lower surfaces through which a plurality of second openings pass. The bubble cap further includes a cap assembly extending upwardly from the substantially annular plate and defining a cavity above the first opening for receiving a distillation plate riser.

### TECHNICAL FIELD

The present technology generally relates to distillation equipment and, more specifically, relates to bubble caps for distillation plates in a fractionating column.

### BACKGROUND

Fractionating columns are used in the distillation of liquid mixtures to separate the constituent parts (i.e., fractions) of a mixture based on their different volatilities. In a typical fractional distillation, a liquid mixture is boiled and the resulting vapor mixture is passed through a fractionating column. The less volatile fractions of the vapor condense on distillation plates inside the column, and the resulting condensate flows downward while cooling and condensing the upflowing vapors, thereby increasing the efficacy of the distillation. When the fractionating column reaches a steady state, the vapor and liquid on each plate reach an equilibrium, with the hottest plate at the bottom of the column and the coolest plate at the top. Only the most volatile fraction remains a gas to the top of the column, from where it can be passed through a condenser to cool and condense it for collection.

The separation of fractions may be enhanced by the addition of more distillation plates to the column, as the plates provide greater interaction between the condensate flowing down through the column and the vapor flowing up. FIG. 1 illustrates one such fractionating column with multiple distillation plates in a schematic cross-sectional view. The fractionating column 100 includes a generally cylindrical body 110, into which a feed line 120 introduces a vapor mixture. A plurality of distillation plates 130 are vertically distributed within the body 110. The vapor mixture bubbles up through the plates 130, interacting with condensate flowing down from the plates (e.g., via downcomers). The most volatile vapor can be removed above the uppermost plate 130 through an outlet line 140 (e.g., leading to a condenser). Condensate which flows to the bottom of the body 110 can be removed via another outlet line 150 (e.g., for returning the condensate to a still or boiler). Alternatively, condensate at the bottom of the body 110 can be heated in-situ by a reboiler to vaporize the condensate and send it back up the body 110 to further interact with down-flowing condensate.

One type of distillation plate is a simple perforated plate, where the vapor passes up through the perforations and bubbles through a condensate trapped above the plate. The condensate can be kept at a predetermined depth during operation by one or more weirs or chimneys, together with the vapor pressure of the gas below the plate. Should the vapor pressure be reduced (e.g., by a reduction in heat at the boiler, or by the exhaustion of the source of the feed vapor), the column can “collapse” (i.e., the condensate can drain down through the perforations and mix back together all the constituent fractions).

To avoid column collapse, another type of distillation plate can be used, in which one or more risers extend upwardly from the plate surface to trap the condensate above the plate. The risers are covered by bubble caps that route the rising vapor down below the surface of the condensate (which is kept at a predetermined depth during operation by one or more weirs or chimneys), before releasing the vapor through openings in the cap to bubble up through the condensate. This kind of distillation plate is not dependent upon the vapor pressure of the gas below the plate to keep the condensate from draining, but rather upon the height of the risers and the chimney/weir.

To increase the efficiency of a fractionating column, it is desirable to increase the interaction between the rising vapor and the downward-flowing condensate. Distillation plates with risers and bubble caps, although they enjoy a resistance to column collapse, generally provide less interaction between the vapor and condensate than perforated plates, due to the volume of condensate through which the vapor does not bubble up (e.g., the condensate below the openings in the bubble caps). Accordingly, it is desirable to provide improved distillation plates and bubble caps for improving the efficiency of fractionating columns.

### BRIEF DESCRIPTION OF THE DRAWINGS

FIG. 1 is a schematic cross-sectional diagram illustrating a fractionating column.

FIG. 2 is a schematic perspective diagram illustrating a distillation plate.

FIG. 3 is a schematic cross-sectional diagram illustrating a distillation plate in a fractionating column.

FIG. 4 is a schematic perspective diagram illustrating a distillation plate.

FIG. 5 is a schematic perspective diagram illustrating a bubble cap.

FIG. 6 is a schematic cross-sectional diagram illustrating a distillation plate with a bubble cap in a fractionating column.

FIG. 7 is a schematic perspective diagram illustrating a bubble cap in accordance with an embodiment of the present technology.

FIG. 8 is a schematic cross-sectional diagram illustrating a distillation plate with a bubble cap in a fractionating column in accordance with an embodiment of the present technology.

FIG. 9 is a schematic cross-sectional diagram illustrating a fractionating column in accordance with an embodiment of the present technology.

FIG. 10 is a flow chart illustrating a method of distilling in accordance with an embodiment of the present technology.

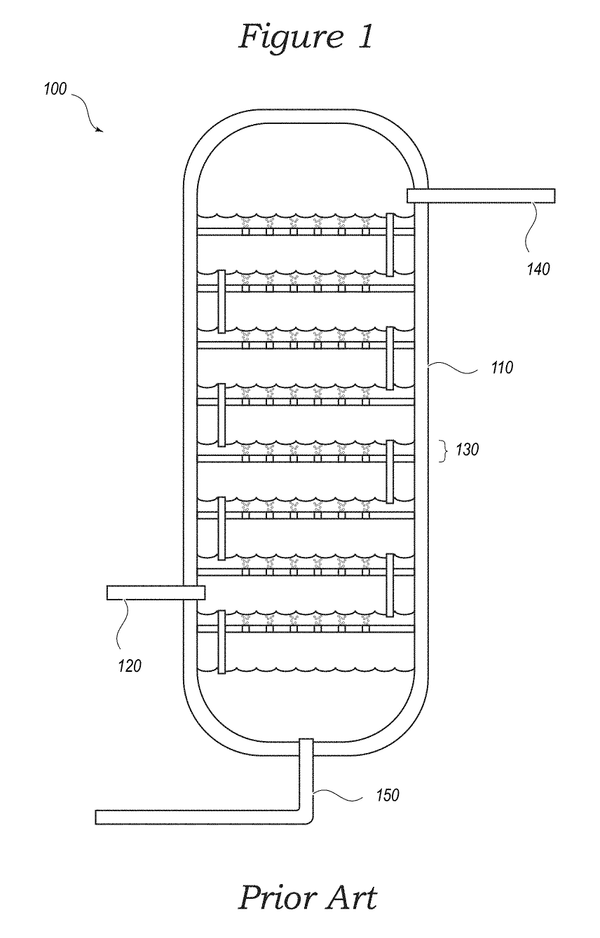

### DETAILED DESCRIPTION

In the following description, numerous specific details are discussed to provide a thorough and enabling description for embodiments of the present technology. One skilled in the relevant art, however, will recognize that the disclosure can be practiced without one or more of the specific details. In other instances, well-known structures or operations often associated with distilling equipment are not shown, or are not described in detail, to avoid obscuring other aspects of the technology. In general, it should be understood that various other devices, systems, and methods in addition to those specific embodiments disclosed herein may be within the scope of the present technology.

As discussed above, distillation plates are designed to increase the interaction between a vapor mixture and a condensate in a fractionating column. The efficiency of a fractionating column depends, at least in part, on the amount of interaction between the vapor mixture and the condensate. In this regard, conventional distillation plate arrangements experience a number of drawbacks that can reduce the efficiency of a fractionating column, or cause other undesirable effects during operation.

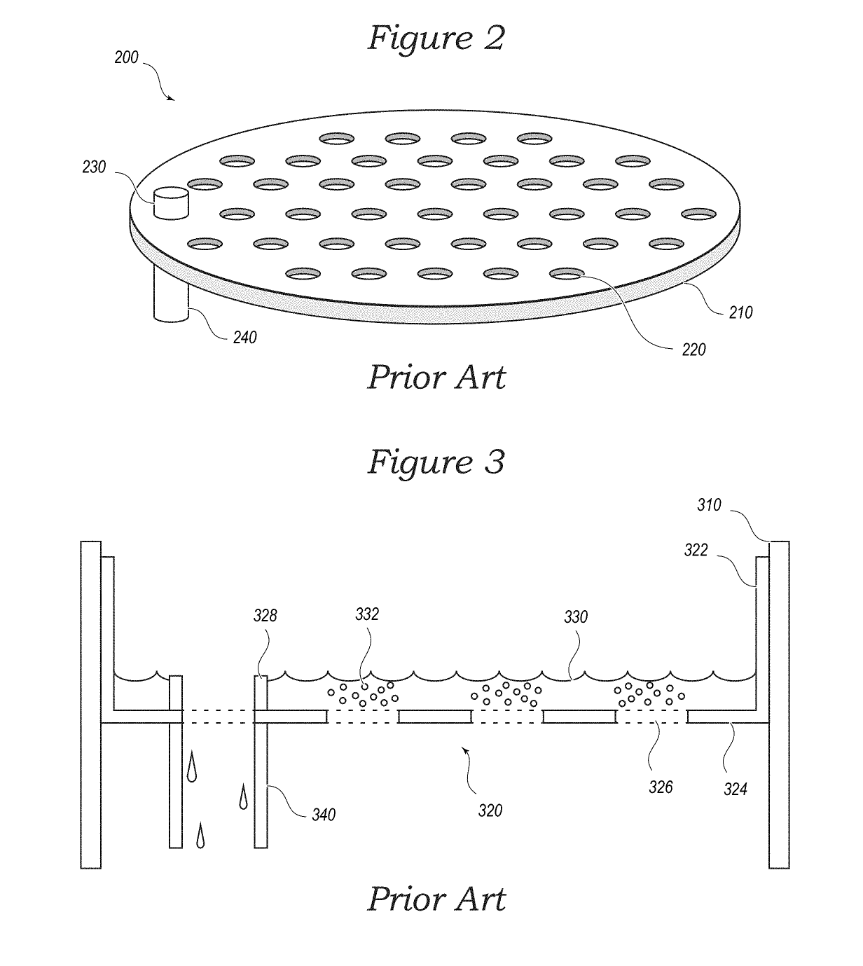

FIG. 2 is a schematic perspective diagram illustrating a simple perforated distillation plate design. The distillation plate 200 has a generally planar body 210 through which one or more perforations or openings, such as opening 220, pass. The perforations allow a vapor mixture to bubble upward through a volume of condensate that is trapped above the body 210 by a combination of vapor pressure and the height of an overflow weir or chimney, such as chimney 230. When the condensate depth reaches the height of the overflow (e.g., chimney 230), additional condensate collecting above the body 210 will flow down through downcomer 240 (e.g., to a lower distillation plate).

This can be more easily seen with reference to FIG. 3, which provides a schematic cross-sectional view of a similar distillation plate during a fractionating operation in a fractionating column. The perforated distillation plate 320 can include side walls 322 attached to the cylindrical body 310 of a fractionating column, and a planar body 324 through which a number of openings 326 pass. The openings 326 permit a vapor mixture 332 to bubble up through the condensate 330 trapped above the planar body 324 of the plate 320 by a combination of vapor pressure and the height of an overflow chimney 328. As additional condensate begins to collect over the plate 320, it overflows the chimney 328 and flows through downcomer 340 (e.g., to a lower distillation plate).

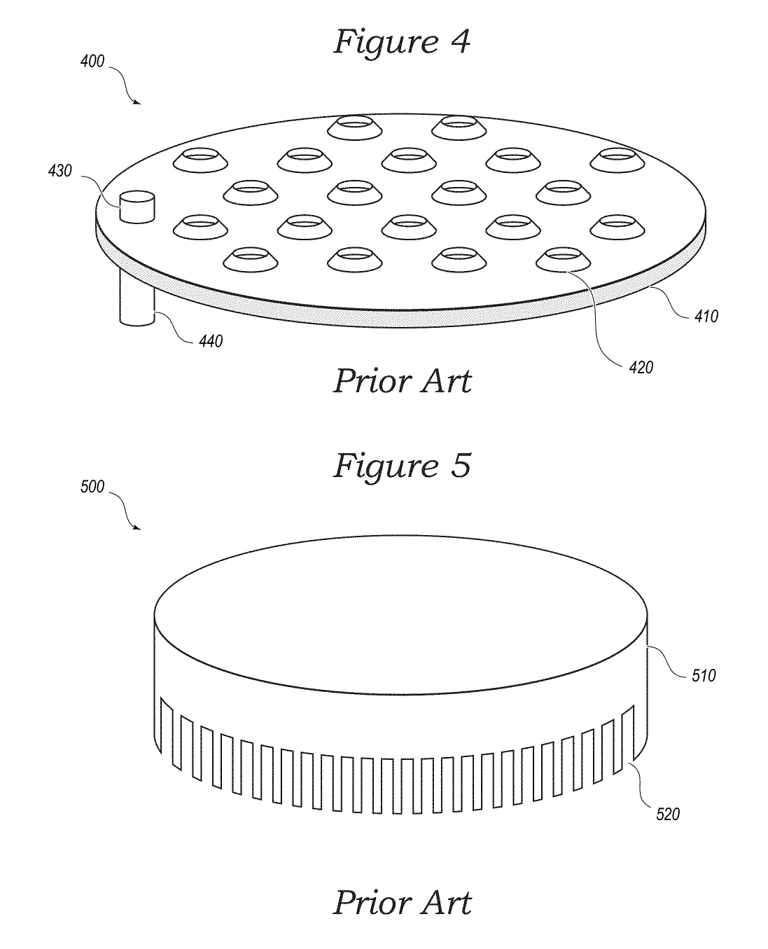

While the simple perforated design of distillation plates 200 (FIG. 2) and 320 (FIG. 3) provides for extensive interaction between the vapor and condensate, it is reliant on continuous vapor pressure from below the plate to prevent condensate from draining to a lower level. To overcome this limitation, a distillation plate with risers may be used instead. One such distillation plate is illustrated in FIG. 4 in a simplified perspective view. The distillation plate 400 includes a generally planar body 410 having one or more risers, such as riser 420, extending upwardly. The risers 420 include an opening above a surface of the planar body 410, which prevents a loss of vapor pressure from causing the condensate to drain through the openings. The distillation plate can further include an overflow weir or chimney, such as chimney 430. When the condensate depth reaches the height of the overflow (e.g., chimney 430), additional condensate collecting above the body 410 will flow down through downcomer 440 (e.g., to a lower distillation plate)

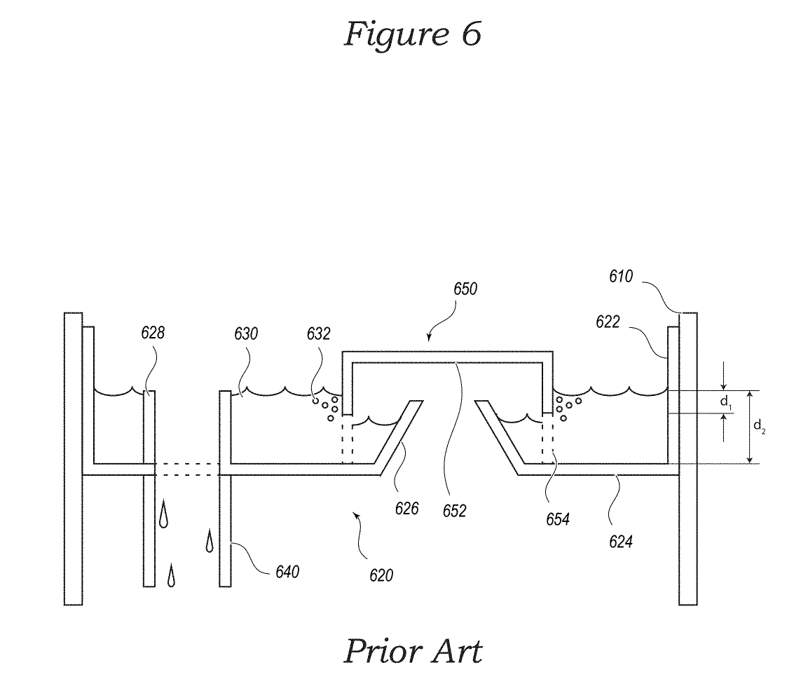

To increase the interaction between the vapor mixture and the condensate, a distillation plate with risers can be provided in a distillation plate assembly in which the risers are covered with bubble caps. The bubble caps route the rising vapor mixture below the surface of the condensate before releasing the vapor through openings in each cap to bubble up through the condensate. A schematic perspective diagram of one such bubble cap is illustrated in FIG. 5. The bubble cap 500 includes a generally cylindrical body 510, closed at the top and open at the bottom. The bubble cap 500 further includes openings 520 along a lower edge of the cylindrical body 510, to allow the vapor mixture to bubble up through the condensate. This can be more easily seen with reference to FIG. 6, which is a schematic cross-sectional diagram illustrating a distillation plate with such a bubble cap during a fractionating operation in a fractionating column.

As illustrated in FIG. 6, the distillation plate 620 can include side walls 622 attached to the cylindrical body 610 of a fractionating column, and a planar body 624 from which a riser 626 extends upwardly. An opening at the top of the riser 626 permits a vapor mixture 632 to rise from below the plate 620 and interact with the condensate 630 above the plate 620. For simplicity of illustration, the distillation plate 620 of FIG. 6 is illustrated with a single riser. The body 652 of the bubble cap 650 defines a cavity above the riser 626, and functions to route the rising vapor mixture 632 below the surface of the condensate 630 trapped above the planar body 624 of the plate 620. The openings 654 in the bubble cap 650 permit the vapor mixture 632 to bubble up through the condensate 630, increasing the interaction between the vapor and the condensate. The condensate is kept to a predetermined depth by a weir or chimney, such as chimney 628, and at least partially prevented from backflowing through the opening at the top of the riser 626 by the height of the riser above the planar body 624 of the plate. As additional condensate begins to collect over the plate 620, it overflows the chimney 628 and flows through downcomer 640 (e.g., to a lower distillation plate).

As can be seen with reference to FIG. 6, a drawback of the conventional bubble cap design is the lack of interaction between the rising vapor mixture and the condensate that is trapped below the uppermost portion of the openings 654 in the cylindrical body 652 of the bubble cap 650. In this regard, although the openings 654 in the bubble cap 650 extend from a first depth d₁ to a second depth d₂ of the condensate (e.g., where d₂ is usually the full depth of the condensate 630), most of the vapor mixture bubbles up through only the shallower first depth d₁ of the condensate 630. This can be addressed by reducing the height of the openings 654 (i.e., increasing d₁), but this reduces the volume of vapor that can pass through the bubble cap 650 (e.g., the cross-sectional area of all of the openings in a bubble cap at least partially defines the capacity of the bubble cap to permit vapor to pass therethrough).

Accordingly, several embodiments of bubble caps in accordance with the present technology can provide improved interaction between a vapor mixture and a condensate in a fractionating column by providing substantially coplanar openings at a substantially uniform depth below the condensate surface. According to one aspect of the present technology, this arrangement overcomes the tendency of conventional bubble caps to permit rising vapor mixtures to take the shortest path through the condensate by escaping out of the uppermost portion of the openings.

Several embodiments of the present technology are directed to bubble caps for distillation plates. The bubble caps can include a substantially annular plate including an inner surface defining a first opening and substantially parallel upper and lower surfaces through which a plurality of second openings pass. The bubble cap can further include a cap assembly extending upwardly from the substantially annular plate and defining a cavity above the first opening for receiving a distillation plate riser.

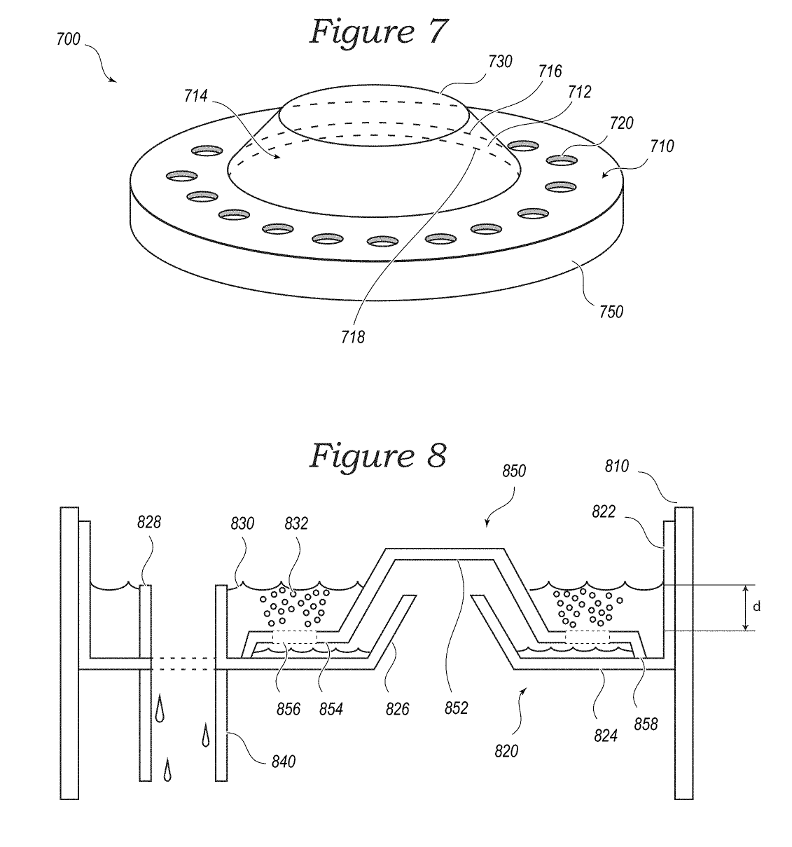

FIG. 7 is a schematic perspective diagram illustrating a bubble cap in accordance with an embodiment of the present technology. The bubble cap 700 can include a substantially annular plate 710 having an inner surface 712 defining a first opening 714. The substantially annular plate 710 includes an upper surface 716 and lower surface 718 through which a plurality of second openings such as opening 720 pass. The bubble cap 700 can include a cap assembly 730 extending upwardly from the substantially annular plate 710 an defining a cavity above the first opening 714. The cavity is configured to receive the riser of a distillation plate (e.g., such as riser 420 of distillation plate 400 of FIG. 4). The bubble cap 700 can further include a foot 750 configured to support the lower surface of the substantially annular plate 710 a distance above a distillation plate.

In various embodiments of the present technology, the bubble cap 700 can be made from any one or more of a number of materials, including copper, stainless steel, or the like. The openings 720 in the bubble cap 700, although illustrated in FIG. 7 as substantially circular openings, can be any one or more of a number of shapes, including rectilinear slits, polygonal holes, mixtures of different shapes, etc. Although the bubble cap 700 of FIG. 7 is illustrated as having openings arranged in a single circular track around the cap assembly 730, in other embodiments, other arrangements of openings can be provided, including multiple circular tracks of openings, a grid of openings, substantially randomly distributed openings, etc. The cross-sectional size of each opening 720 may be selected based on the intended use of the bubble cap 700 (e.g., depending upon the composition of the vapor mixture and the condensate, the vapor pressure and other operating parameters in the fractionating column, etc.).

Although in the present embodiment, the bubble cap 700 is illustrated in a radially symmetric configuration, in other embodiments, bubble caps can be arranged non-symmetrically. For example, rather than an annular plate coaxially aligned with a cap central assembly, in another embodiment of the present technology a bubble cap can have a cap assembly configured to receive a distillation plate riser offset to one side of a plate with substantially co-planar openings. Moreover, although in the present embodiment, the bubble cap 700 is illustrated with a substantially horizontal annular plate 710, in other embodiments of the present technology bubble caps can be provided with plates having different arrangements. For example, a bubble cap can be provided with a conical annular surface or other gently sloped (e.g., less than 30) surface in which openings are provided.

Although in the embodiments of FIG. 6 and FIG. 7, bubble caps having bubble cap assemblies with substantially frustoconical shapes are illustrated, in other embodiments a bubble cap can have a cap assembly with any one of a number of different shapes. In this regard, if the riser over which the bubble cap is to be disposed extends upwardly from a distillation plate with a generally conical shape (e.g., as in FIG. 7), the cap assembly can be provided with a similar conical or frustoconical profile. If the riser extends upwardly from the distillation plate with a different profile (e.g., cylindrical, hemispherical, or the like), the bubble cap may have a cap assembly with a similar profile. Alternatively, in other embodiments a bubble cap can have a cap assembly with a profile which differs from the profile of the distillation plate riser over which it is to be disposed (e.g., a cap assembly can have a hemispherical or truncated hemispherical profile over a conical or cylindrical riser).

FIG. 8 is a schematic cross-sectional diagram illustrating a distillation plate with a bubble cap in a fractionating column in accordance with an embodiment of the present technology. The distillation plate 820 can include side walls 822 attached to the cylindrical body 810 of a fractionating column, and a planar body 824 from which a riser 826 extends upwardly. For simplicity of illustration, the distillation plate 820 of FIG. 8 is illustrated with a single riser, but those skilled in the art will appreciate that distillation plates with more than one riser similarly configured can also be used. An opening at the top of the riser 826 permits a vapor mixture 832 to rise from below the plate 820 and interact with the condensate 830 above the plate. The bubble cap 850 includes a cap assembly 852 that defines a cavity above the riser 826, and that functions to route the rising vapor mixture 832 below the surface of the condensate 830 trapped above the planar body 824 of the plate 820. The bubble cap 850 includes a substantially annular plate 854 with substantially co-planar openings 856 that permit the vapor mixture 832 to bubble up through the condensate 830, increasing the interaction between the vapor and the condensate. Because the openings 856 in bubble cap 850 are substantially co-planar (e.g., all about the same depth d below the surface of the condensate 830), the vapor mixture 832 interacts with (e.g., by bubbling through) the entire depth d of the condensate 830 above the substantially annular plate 854 of the bubble cap 850.

The condensate above the distillation plate 820 can be kept to a predetermined depth by a weir or chimney, such as chimney 828, and at least partially prevented from backflowing through the opening at the top of the riser 826 by the height of the riser above the planar body 824 of the plate 820. As additional condensate begins to collect over the plate 820, it overflows the chimney 828 and flows through downcomer 840 (e.g., to a lower distillation plate).

The bubble cap 850 further includes a foot 858 that supports the substantially annular plate 854 a distance above the upper surface of the distillation plate 820. The foot 858 permits vapor rising through the riser 826 to route between the substantially annular plate 858 and the distillation plate 820 to the openings 856). The height of the foot 858 can be selected to provide a desired depth d of the condensate 830 above the substantially annular plate 854. Although in the embodiment illustrated in FIG. 8, the foot 858 of the bubble cap 850 is shown disposed over a planar distillation plate 820, in other embodiments, the distillation plate 820 may include a recess surrounding the riser 826 in which the bubble cap 850 is disposed (e.g., so that the depth d of the condensate 830 above the substantially annular plate 854 of the bubble cap is substantially equal to the greatest depth of the condensate 830 over any region of the distillation plate 820). Moreover, the foot 858 of the bubble cap 850 can be attached to the distillation plate 820 in any one of a number of ways, including soldering, crimping, friction fitting, or alternatively held in place over the riser 826 by its own weight. Although the foot 858 is illustrated in the embodiment set forth in FIG. 8 as a continuous substantially cylindrical or conical wall extending down from the substantially annular plate 854 of the bubble cap 850, in other embodiments a bubble cap can be provided with multiple discrete feet (e.g., legs or posts) supporting the substantially annular plate of a bubble cap above a distillation plate. Similarly, although in the embodiment illustrated in FIG. 8, the distillation plate 820 includes sidewalls 822 attached to the fractionating column (e.g., in a “distillation tray” configuration), in other embodiments distillation plates can be disposed in and/or attached to fractionating columns in any one of a number of ways, including friction fitting, soldering, etc.

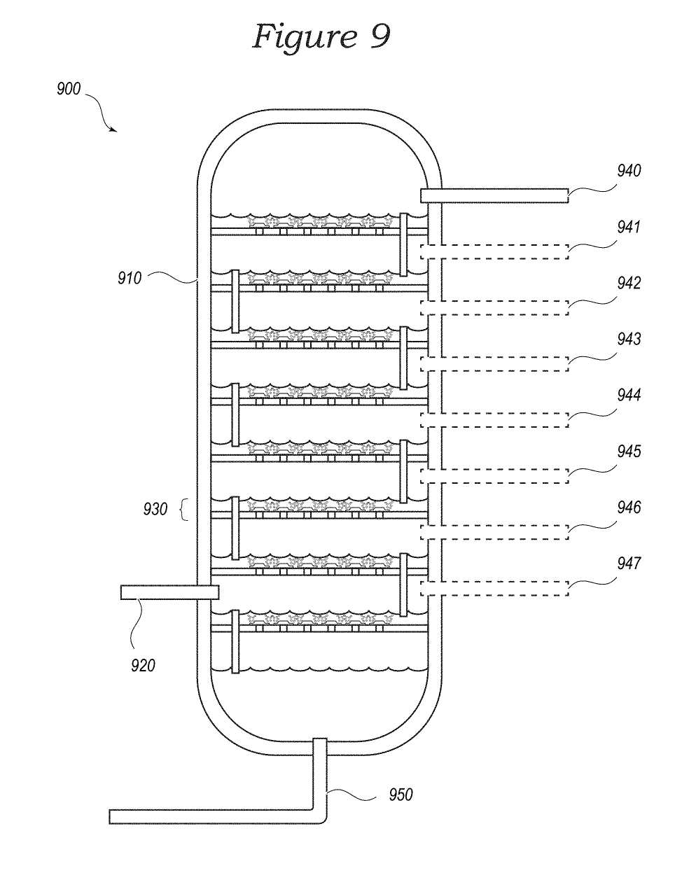

FIG. 9 is a schematic cross-sectional diagram illustrating a fractionating column in accordance with an embodiment of the present technology. The fractionating column 900 includes a body 910 into which a feed line 920 introduces a vapor mixture. A plurality of distillation plates 930 are vertically distributed within the body 910. Each plate can include one or more risers covered by corresponding bubble caps, with features similar to the bubble caps described in greater detail above with respect to FIGS. 7 and 8. The vapor mixture bubbles up through the plates 930, interacting with condensate flowing down from the plates 930 (e.g., via downcomers). The most volatile vapor can be removed above the uppermost plate 930 through an outlet line 940 (e.g., leading to a condenser). Moreover, additional outlet lines 941-947 can optionally be provided above lower-lying plates 930 to remove less volatile vapors from above those plates, if desired. Condensate which flows to the bottom of the body 910 can be removed via another outlet line 950 (e.g., for returning the condensate to a still or boiler). Alternatively, condensate at the bottom of the body 910 can be heated in-situ by a reboiler to vaporize the condensate and send it back up the body 910 to further interact with down-flowing condensate.

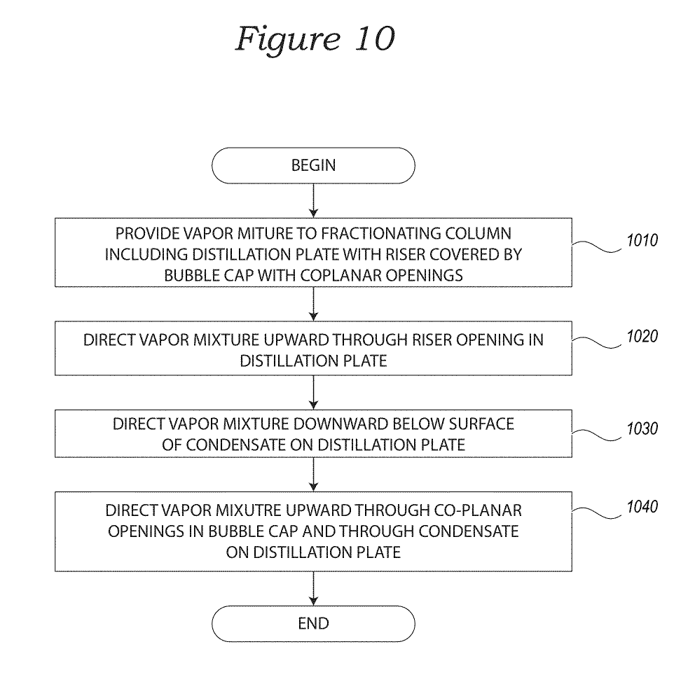

FIG. 10 is a flow chart illustrating a method of distilling in accordance with an embodiment of the present technology. The method includes providing a vapor mixture to a fractionating column (box 1010) including at least one distillation plate having at least one riser covered by a bubble cap. The bubble cap can include a substantially annular plate including an inner surface defining a first opening and substantially parallel upper and lower surfaces through which a plurality of second openings pass. The bubble cap can further include a cap assembly extending upwardly from the substantially annular plate and defining a cavity above the first opening for receiving a riser of the distillation plate. The method further includes directing the vapor mixture upward through a riser opening in the distillation plate (box 1020), downward below a surface of a condensate on the distillation plate (box 1030), and upward through co-planar openings in the bubble cap and through the condensate on the distillation plate (box 1040).

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A bubble cap, comprising:
a substantially annular plate including an inner surface defining a first opening and upper and lower surfaces through which a plurality of second openings pass; and
a cap assembly extending upwardly from the substantially annular plate and defining a cavity above the first opening for receiving a distillation plate riser.

2. The bubble cap of claim 1, further comprising a foot configured to support the substantially annular plate above the distillation plate.

3. The bubble cap of claim 2, wherein the foot comprises a wall extending downwardly from a periphery of the substantially annular plate.

4. The bubble cap of claim 1, wherein the bubble cap comprises copper or stainless steel.

5. The bubble cap of claim 1, wherein the cap assembly is one of substantially frustoconical, substantially hemispherical, and substantially cylindrical in shape.

6. The bubble cap of claim 1, wherein the plurality of second openings comprise substantially rectilinear slits.

7. The bubble cap of claim 1, wherein the plurality of second openings comprise substantially circular holes.

8. The bubble cap of claim 1, wherein the bubble cap is configured to provide a path for vapor received from the riser upwardly through the plurality of second openings.

9. The bubble cap of claim 1, wherein the upper and lower surfaces are substantially parallel.

10. A distillation plate assembly for a fractionating column, comprising:
a substantially planar distillation plate including one or more risers, each riser extending upwardly from an upper surface of the substantially planar distillation plate and including an opening;
one or more bubble caps, each bubble cap disposed over a corresponding one of the one or more risers, each bubble cap including:
a substantially annular plate having an inner surface defining a first opening and substantially parallel upper and lower surfaces through which a plurality of second openings pass; and
a cap assembly extending upwardly from the substantially annular plate and defining a cavity above the first opening for receiving the corresponding riser.

11. The distillation plate assembly of claim 10, further comprising an overflow configured to drain a condensate from above the distillation plate.

12. The distillation plate assembly of claim 10, wherein each bubble cap further includes a foot configured to support the substantially annular plate above the distillation plate.

13. The distillation plate assembly of claim 12, wherein the foot comprises a wall extending downwardly from a periphery of the substantially annular plate.

14. The distillation plate assembly of claim 10, wherein the one or more bubble caps comprise copper or stainless steel.

15. The distillation plate assembly of claim 10, wherein the distillation plate comprises copper or stainless steel.

16. The distillation plate assembly of claim 10, wherein the cap assembly of each of the one or more bubble caps is one of substantially frustoconical, substantially hemispherical, and substantially cylindrical in shape.

17. The distillation plate assembly of claim 10, wherein the plurality of second openings comprise one or more of substantially rectilinear slits and substantially circular holes.

18. The distillation plate assembly of claim 10, wherein the one or more bubble caps are configured to provide a path for vapor received from the riser upwardly through the plurality of second openings.

19. The distillation plate assembly of claim 10, wherein the substantially annular plate of the one or more bubble caps is below an uppermost portion of the corresponding one of the one or more risers.

20. A fractionating column assembly, comprising:
a fractionating column;
one or more distillation plate assemblies disposed within the fractionating column, each of the one or more distillation plate assemblies including:
a substantially planar distillation plate having one or more plate openings therethrough;
one or more risers, each riser extending upwardly from a corresponding one of the one or more plate openings;
one or more bubble caps, each bubble cap disposed over a corresponding one of the one or more risers, each bubble cap having:
a substantially annular plate with an inner surface defining a first opening and substantially parallel upper and lower surfaces through which a plurality of second openings pass; and
a cap assembly extending upwardly from the substantially annular plate and defining a cavity above the first opening for receiving the corresponding riser.
